(19) United States
(12) Patent Application Publication
(10) Pub. No.: US 2016/0150111 A1
(43) Pub. Date: May 26, 2016

(54) Electronic Device that Detects Return Timing in Low Electric Power Consumption Mode with Low Electric Power Consumption

(71) Applicant: Kyocera Document Solutions Inc., Osaka (JP)

(72) Inventor: Yasuaki Sakamoto, Osaka (JP)

(21) Appl. No.: 14/945,428

(22) Filed: Nov. 19, 2015

(30) Foreign Application Priority Data
Nov. 21, 2014 (JP) 2014-236414

(51) Int. Cl. H04N 1/00; G06K 9/00

(52) U.S. Cl. CPC H04N 1/00891; H04N 1/00204; H04N 1/00896; G06K 9/00369; H04N 2201/0094

(57) ABSTRACT

An electronic device includes an operation panel, an electric power control circuit, an operation confirming circuit, an electric power mode switching circuit, a human body detecting circuit, and a cycle changing circuit. The electric power control circuit switches a plurality of electric power supply modes including a standby mode and a low electric power consumption mode that uses less electric power consumption amount than the standby mode. The operation confirming circuit periodically confirms an operation to the operation panel in the low electric power consumption mode. The electric power mode switching circuit causes the electric power control circuit to switch the electric power supply mode when the operation confirming circuit detects the operation to the operation panel. The cycle changing circuit changes an operation confirmation cycle by the operation confirming circuit corresponding to a detection state of the human body detecting circuit.

### INCORPORATION BY REFERENCE

This application is based upon, and claims the benefit of priority from, corresponding Japanese Patent Application No. 2014-236414 filed in the Japan Patent Office on Nov. 21, 2014, the entire contents of which are incorporated herein by reference.

### BACKGROUND

Unless otherwise indicated herein, the description in this section is not prior art to the claims in this application and is not admitted to be prior art by inclusion in this section.

A multi-function peripheral (MFP) having a plurality of functions such as an image reading function, a printing function, a facsimile function, and a document accumulation function has widely used in offices and similar place in recent years. The multi-functional peripheral is often connected to an information processing terminal such as a personal computer via a network such as a local area network (LAN) in the offices and similar place, and shared among a plurality of users.

This multi-functional peripheral widely employs a function that switches from an electric power supply mode that supplies electric power to the whole multi-functional peripheral to a low electric power consumption mode (a sleep mode) that uses a reduced amount of electric power consumption when, for example being unused, so as to ensure the reduced environmental load. When, for example, an operation panel is operated or an instruction is input via a network, the multi-functional peripheral in a state of the low electric power consumption mode returns from the low electric power consumption mode to a standby mode, which can execute a part of or all the functions of the multi-functional peripheral, corresponding to this instruction.

From the view point of reducing a waiting time of the user who is about to use the multi-functional peripheral, It is preferred to promptly perform the return from the low electric power consumption mode to the standby mode. Especially, it is preferred that the return be completed before the user starts to use the multi-functional peripheral. Thus, there is known a configuration that starts the return based on a user's previous action rather than, as described above, when detecting an operation or inputting an instruction. For example, there is an image forming apparatus having a function of returning from the low electric power consumption mode to the standby mode when the user approaches the apparatus using a human body detection sensor to detect a movement direction of a human to the apparatus.

### SUMMARY

An electronic device according to one aspect of the disclosure includes an operation panel, an electric power control circuit, an operation confirming circuit, an electric power mode switching circuit, a human body detecting circuit, and a cycle changing circuit. The operation panel receives an operation. The electric power control circuit switches a plurality of electric power supply modes including a standby mode that ensures execution of at least one function and a low electric power consumption mode that uses less electric power consumption amount than an electric power consumption amount of the standby mode. The operation confirming circuit periodically confirms an operation to the operation panel in the low electric power consumption mode. The electric power mode switching circuit causes the electric power control circuit to switch the electric power supply mode when the operation confirming circuit detects the operation to the operation panel. The human body detecting circuit detects existence of a human body within a predetermined range. The cycle changing circuit changes an operation confirmation cycle by the operation confirming circuit corresponding to a detection state of the human body detecting circuit.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

FIG. 1 schematically illustrates an overall configuration of a multi-functional peripheral according to one embodiment of the disclosure.

FIG. 2 schematically illustrates an operation panel of the multi-functional peripheral according to the one embodiment.

FIG. 3 illustrates a hardware configuration of the multi-functional peripheral according to the one embodiment.

FIG. 4 illustrates the multi-functional peripheral according to the one embodiment.

FIG. 5 schematically illustrates a cyclic operation confirmation executed by the multi-functional peripheral according to the one embodiment.

FIG. 6 illustrates an exemplary operation confirmation procedure executed by the multi-functional peripheral according to the one embodiment.

FIGS. 7A to 7C schematically illustrate an exemplary relationship between a human body detection state and an operation confirmation cycle according to the one embodiment.

### DETAILED DESCRIPTION

Example apparatuses are described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

The following describes an embodiment of the disclosure in detail with reference to the drawings. Additionally, the following embodies the disclosure as a digital multi-functional peripheral. The digital multi-functional peripheral of the embodiment is configured for being executable of a plurality of functions including an image reading function, an image formation function (a copy function and a printer function), and a network sending and receiving function. Here, one or more units among an image reading unit, an image forming unit, and a network interface achieves the respective functions. The image reading unit, the image forming unit, and the network interface configure as one or more units, which are each independent and available to supply electric power.

The digital multi-functional peripheral is configured to be switchable among a plurality of electric power supply modes including a standby mode and a low electric power consumption mode (a sleep mode). The standby mode is a mode where electric power is supplied to one or more units, and at least one function (an image processing) is executable. The low electric power consumption mode is a mode where the minimum electric power required for, for example, receiving an instruction input from an outside is supplied to ensure a reduced electric power consumption amount compared with the standby mode.

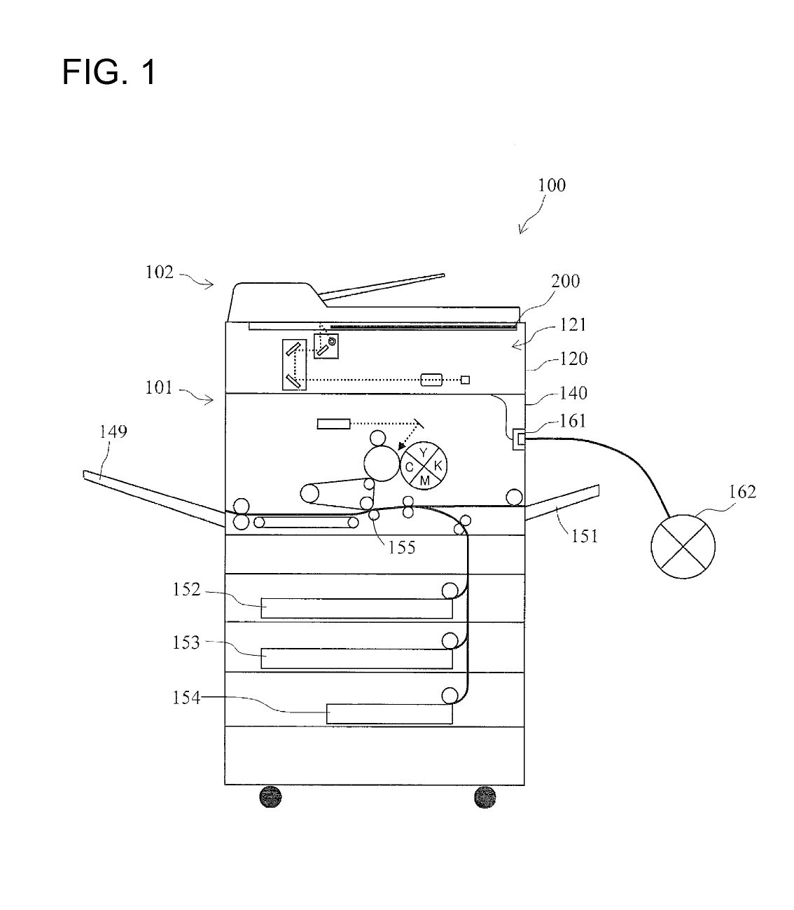

FIG. 1 schematically illustrates an exemplary overall configuration of the digital multi-functional peripheral according to the embodiment. As illustrated in FIG. 1, a multi-functional peripheral 100 includes a main body 101, which includes an image reading unit 120 and an image forming unit 140 (which is also referred to as image forming circuit), and a platen cover 102 mounted on an upper side of the main body 101. An operation panel 200, with which a user can give an instruction of a copy start or another instruction to the multi-functional peripheral 100, and can see a state and a setting of the multi-functional peripheral 100, is located on a front surface of the multi-functional peripheral 100.

The image reading unit 120 is located in an upper portion of the main body 101. The image reading unit 120 reads an image of an original document using a scanning optical system 121 to generate digital data (image data) of the image.

The image forming unit 140 can print the generated image data on a paper sheet. A network interface 161 may transmit the generated image data to another device (not illustrated) via a network 162.

The image forming unit 140 prints the image data generated by the image reading unit 120 and image data received from another device connected to the network 162 on a paper sheet. The image forming unit 140 feeds a paper sheet to a transfer unit 155, which transfers a toner image, from, for example, a bypass tray 151, sheet feed cassettes 152, 153, and 154. The transfer unit 155 discharges the paper sheet on which the toner image is transferred to a sheet discharge tray 149.

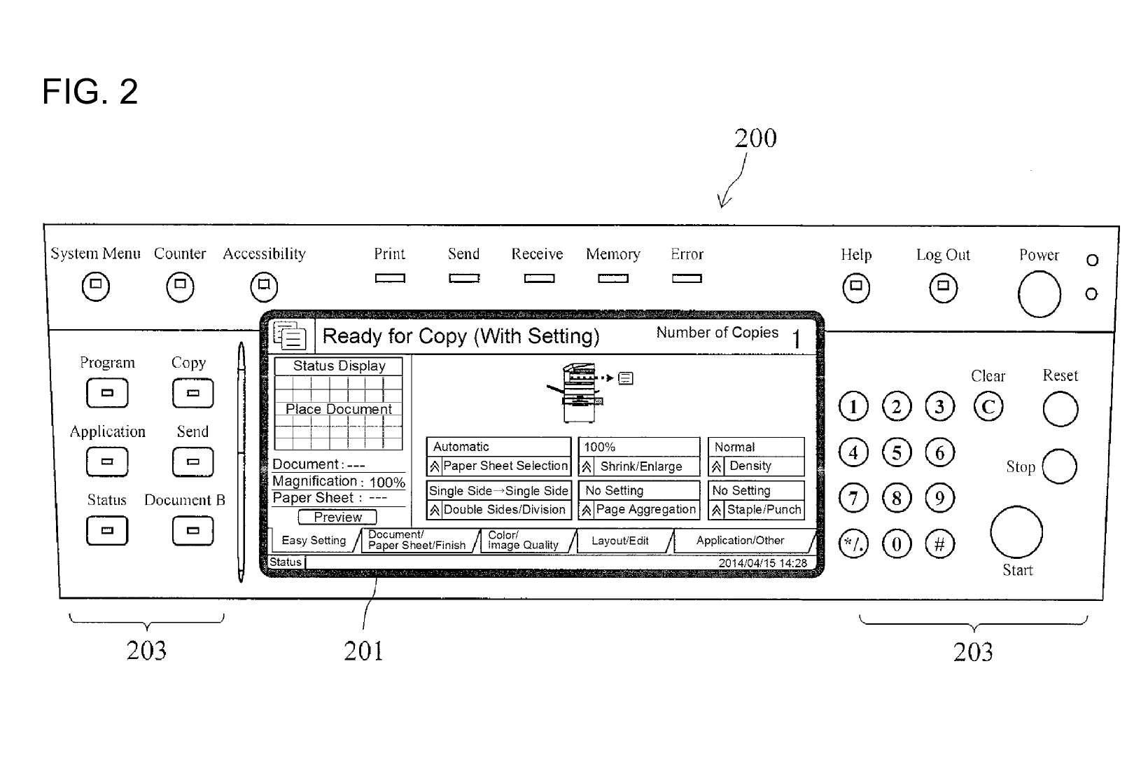

FIG. 2 illustrates an exemplary external appearance of an operation panel included in the multi-functional peripheral. The user can give an instruction of a copy start or another instruction to the multi-functional peripheral 100, and can see a state and a setting of the multi-functional peripheral 100 using the operation panel 200.

A touch panel display 201 and an operation button 203, which function as an operated circuit, are located in the operation panel 200. The touch panel display 201 includes a display surface, which includes, for example, the operation button 203 and a liquid crystal display that displays, for example, a message, and a sensor, which detects a pressing force position on this display surface. Detection method of a pressing force position is not specifically limited. Any method such as a resistance film method, a capacitive type method, a surface acoustic wave method, and an electromagnetic wave method may be employed. The user can input via the touch panel display 201 using, for example, his or her finger.

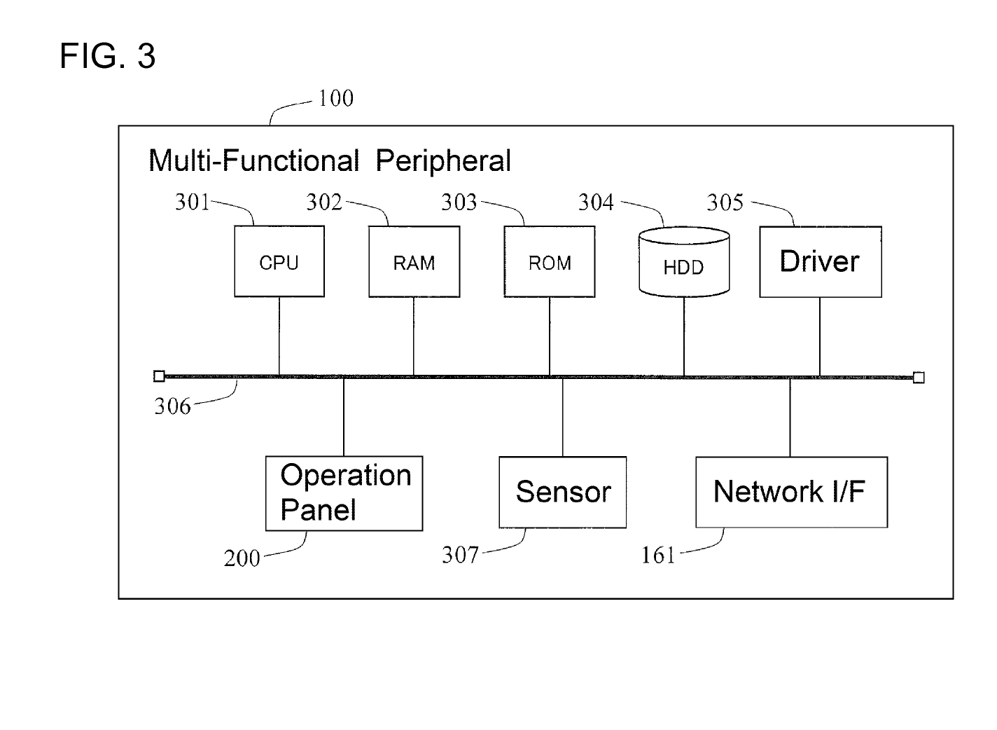

FIG. 3 illustrates a hardware configuration of a control system in the multi-functional peripheral. In the multi-functional peripheral 100 of the embodiment, a driver 305, which corresponds to respective driving units of a central processing unit (CPU) 301, a random access memory (RAM) 302, a read only memory (ROM) 303, a hard disk drive (HDD) 304, the image reading unit 120, and the image forming unit 140, is connected via an internal bus 306. The ROM 303, the HDD 304 or similar memory store programs. The CPU 301 controls the multi-functional peripheral 100 in accordance with a command of one of the programs or a control program. For example, the CPU 301 uses the RAM 302 as a work area to exchange data and an instruction with the driver 305. This controls operations of the respective driving units described above. The HDD 304 is used for an accumulation of image data obtained by the image reading unit 120 and image data received from another device via the network interface 161.

The operation panel 200 and various kinds of sensors 307 are additionally connected to the internal bus 306. The operation panel 200 accepts a user operation to supply a signal based on its operation to the CPU 301. The touch panel display 201 displays an operation screen described above in accordance with a control signal from the CPU 301. The sensor 307 includes various kinds of sensors such as an open and close detection sensor of the platen cover 102, an original document detection sensor on a platen, a temperature sensor for a fixing unit, a detection sensor for a paper sheet or an original document to be conveyed.

The CPU 301, for example, executes the program stored in the ROM 303 to execute functions of the following respective units (a function block), and to control operations of the respective units corresponding to a signal from these sensors.

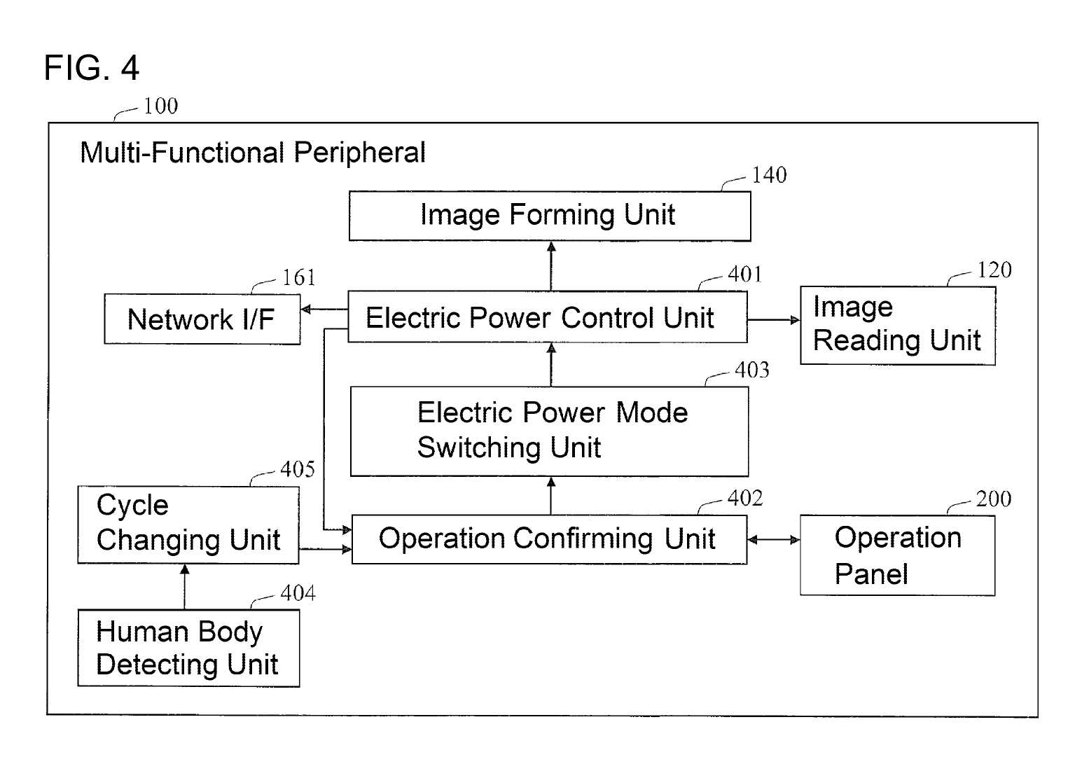

FIG. 4 illustrates the multi-functional peripheral 100 of the embodiment. As illustrated in FIG. 4, the multi-functional peripheral 100 of the embodiment includes an electric power control unit 401 (which is also referred to as electric power control circuit), an operation confirming unit 402 (which is also referred to as operation confirming circuit), an electric power mode switching unit 403 (which is also referred to as electric power mode switching circuit), a human body detecting unit 404 (which is also referred to as human body detecting circuit), and a cycle changing unit 405 (which is also referred to as cycle changing circuit).

The electric power control unit 401 switches among the plurality of the electric power supply modes including the standby mode and the low electric power consumption mode. The standby mode is a mode where at least one function of the multi-functional peripheral 100 is executable. The low electric power consumption mode is a mode where the electric power consumption amount is less than this standby mode. The standby mode includes a mode where the multi-functional peripheral 100 can execute immediately only one function among the respective functions (the image reading function, the image formation function, the network sending and receiving function), which are executable for the multi-functional peripheral 100. The standby mode additionally includes a mode where the multi-functional peripheral 100 can execute immediately only a part of a plurality of the functions (for example, a mode where power delivery to a device, such as the fixing unit consuming large electric power, is stopped, and this inhibits the multi-functional peripheral 100 from executing immediately the image formation function) and a mode where the multi-functional peripheral 100 can execute all the functions immediately. In the low electric power consumption mode, supplying electric power to only a part of the multi-functional peripheral 100 maintains a state where the multi-functional peripheral 100 can detect whether or not a switching condition from the low electric power consumption mode to another electric power supply mode is fulfilled. For example, this stops an electric power supply to sensors (for example, a platen cover open and close detection sensor and an original document detection sensor) unrelated to the detection whether or not the switching condition is fulfilled, the RAM 302, the HDD 304, and respective units (the image reading unit 120 and the image forming unit 140), for example. Only minimum electric power required for the detection described above is also supplied to the CPU 301. Consequently, the multi-functional peripheral 100 cannot execute an image processing in the low electric power consumption mode.

Fulfilling preliminarily registered conditions causes a switching from the standby mode to the low electric power consumption mode and a switching from the low electric power consumption mode to the standby mode. In the embodiment, when a state where an instruction is not received by the multi-functional peripheral 100 continues for a preliminarily specified certain period in the standby mode as the electric power supply mode, the electric power control unit 401 switches from the standby mode to the low electric power consumption mode. When an instruction is received by the multi-functional peripheral 100 in the low electric power consumption mode as the electric power supply mode, the electric power control unit 401 switches from the low electric power consumption mode to the standby mode as necessary.

The operation confirming unit 402 periodically confirms an operation to the operation panel 200 in the low electric power consumption mode. In the embodiment, the operation confirming unit 402 detects a press of the operation button 203 on the operation panel 200 and a pressing force to a display surface of the touch panel display 201. The operation confirming unit 402 can detect the press of the operation button 203 based on a signal indicating a press of each button output from the operation panel 200. The operation confirming unit 402 similarly can detect the pressing force to the display surface of the touch panel display 201 based on a signal indicating a pressing force position output from the sensor of the touch panel display 201 to detect the pressing force position.

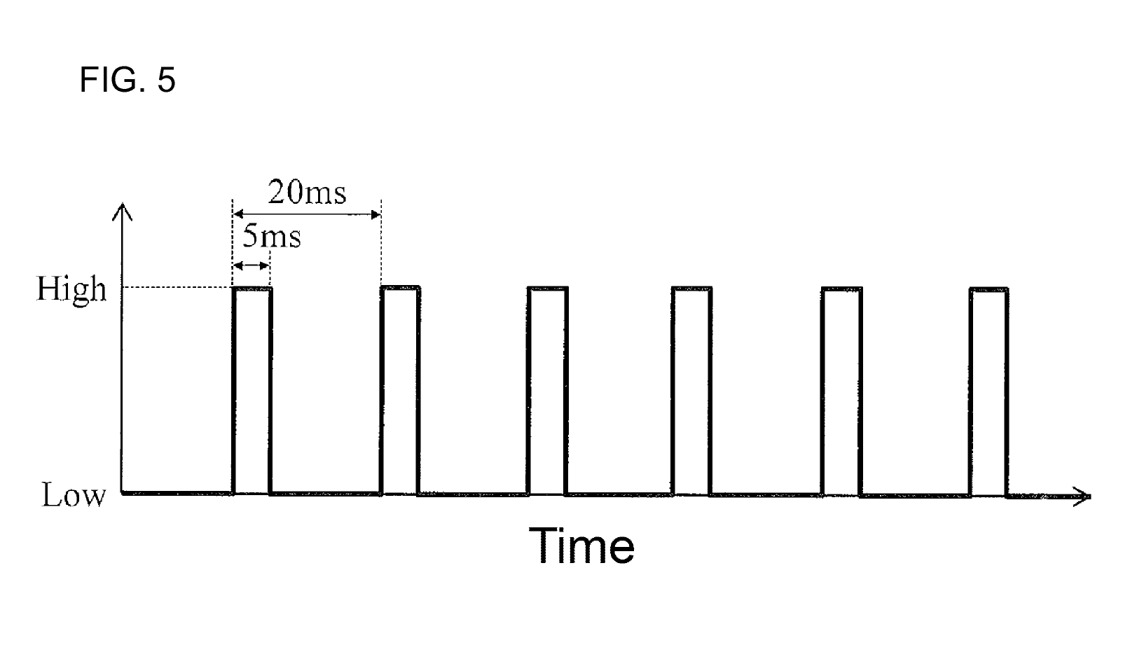

FIG. 5 schematically illustrates a cyclic operation confirmation executed by the operation confirming unit 402. In FIG. 5, the horizontal axis corresponds to a time, and the vertical axis corresponds to a signal level of an operation confirmation timing signal. When the operation confirmation timing signal is at a “High” level, the operation confirming unit 402 detects existence of the press of the operation button 203 or the pressing force to the touch panel display 201 based on the signal indicating the press of the each button output from the operation panel 200 and a signal indicating the pressing force position output from the touch panel display 201 at that time. When the operation confirmation timing signal is at a “Low” level, the operation confirming unit 402 does not perform an operation confirmation.

FIG. 5 illustrates an example that an operation confirmation within periods of 5 ms repeats every period of 20 ms. In this example, the operation confirming unit 402 confirms sequentially output signals corresponding to respective buttons of the operation button 203 and an output signal corresponding to a pressing force position of the touch panel display 201 within the periods of 5 ms. When one of output signals indicates the press or the pressing force position, the operation confirming unit 402 detects that the operation panel 200 is operated. Here, the operation confirming unit 402 confirms all the output signals corresponding to the respective buttons of the operation button 203 and all the output signals corresponding to the pressing force position of the touch panel display 201 within one period at which the signal level of the operation confirmation timing signal is the High level. However, the operation confirming unit 402 may confirm all the output signals corresponding to the respective buttons of the operation button 203 and all the output signals corresponding to the pressing force position of the touch panel display 201 within a plurality of periods at which the signal level of the operation confirmation timing signal is the High level. Namely, the operation confirming unit 402 may confirm the existence of the press of the operation button 203 on a left side of the touch panel display 201 in FIG. 2 within the first High level period, confirm an operation to the touch panel display 201 within the next High level period, and then confirm the existence of the press of the operation button 203 on a right side of the touch panel display 201 within the subsequent High level period. In this case, the operation confirming unit 402 repeatedly performs a sequence of operation confirmation every three continuous High level periods.

The electric power mode switching unit 403 causes the electric power control unit 401 to switch the electric power supply mode when the operation confirming unit 402 detects the operation (the operation to the touch panel display 201 or the operation button 203) to the operation panel 200. When the operation confirming unit 402 confirms the operation to the operation panel 200 in the low electric power consumption mode of the embodiment, the electric power mode switching unit 403 causes the electric power control unit 401 to switch the electric power mode from the low electric power consumption mode to the standby mode. When the operation confirming unit 402 does not detect the operation to the operation panel 200 in the low electric power consumption mode, the electric power mode switching unit 403 does not cause the electric power control unit 401 to switch any mode. Namely, the electric power control unit 401 maintains the low electric power consumption mode.

The human body detecting unit 404 detects existence of a human body within a predetermined range. The human body detecting unit 404 can include any known configuration that can detect existence of a human body. For example, it may be employed that a configuration that can detect the existence of the human body within the predetermined range from the multi-functional peripheral 100 using a pyroelectric type infrared sensor or a diode type (quantum type) infrared sensor. Not specifically limited, the pyroelectric type infrared sensor, which consumes less electric power, configures the human body detecting unit 404 of the embodiment. The infrared sensor can be located on the front surface of the multi-functional peripheral 100 (for example, a front surface of the operation panel 200).

The human body detecting unit 404 of the embodiment includes a configuration that can detect a distance between the multi-functional peripheral 100 and a human body. Not specifically limited, the embodiment employs a configuration that a plurality of pyroelectric type infrared sensors, which differs in a detectable distance (a detectable range), are located to detect the distance between the multi-functional peripheral 100 and the human body based on human body detection states of the respective sensors. For example, a disposition of two infrared sensors, which differ in a detectable distance, causes the human body detecting unit 404 to distinctively detect a human body near the multi-functional peripheral 100 (which is detected by at least the infrared sensor whose detectable distance is short) from a human body who is partly separate from the multi-functional peripheral 100 (which is detected by at least by the infrared sensor whose detectable distance is long). Another known configuration may be employed to detect the distance between the multi-functional peripheral 100 and the human body.

The cycle changing unit 405 changes a cycle of an operation confirmation performed by the operation confirming unit 402 corresponding to a detection state of the human body detecting unit 404. As described above, the human body detecting unit 404 of the embodiment includes a configuration that can detect the distance between the multi-functional peripheral 100 and the human body. Thus, the cycle changing unit 405 also employs a configuration that changes the operation confirmation cycle corresponding to the distance between the multi-functional peripheral 100 and the human body detected by the human body detecting unit 404. Namely, the cycle changing unit 405 includes a configuration that the more separated the distance between the multi-functional peripheral 100 and the human body detected by the human body detecting unit 404 is, the larger the operation confirmation cycle becomes.

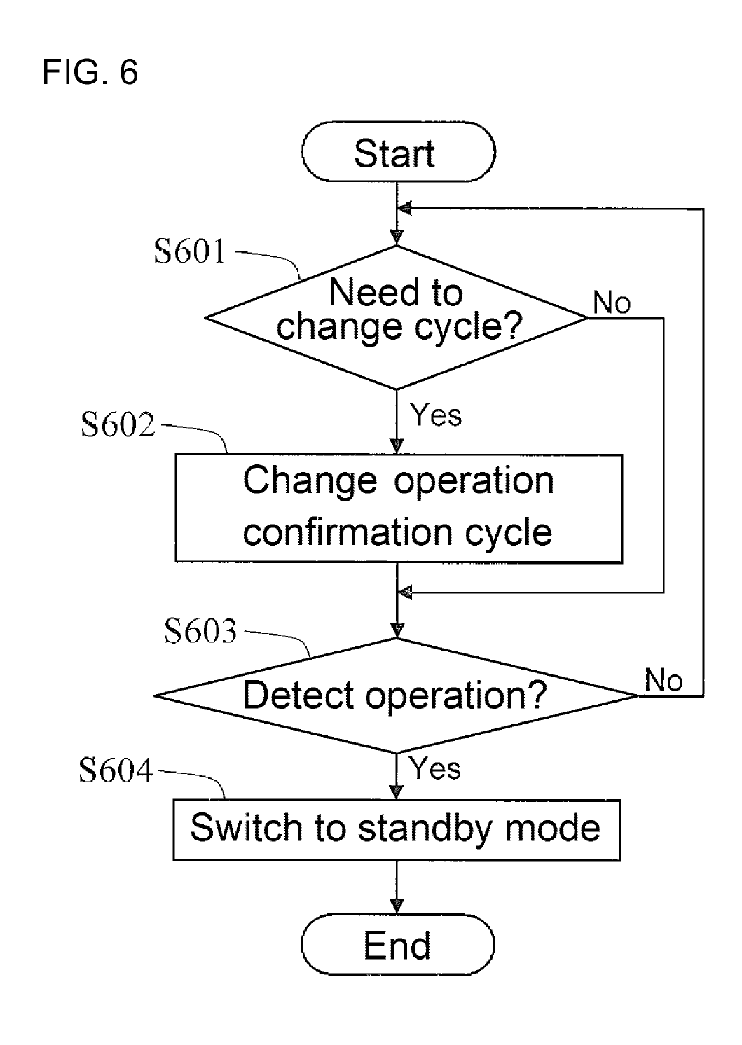

FIG. 6 illustrates an exemplary operation confirmation procedure executed by the multi-functional peripheral 100. This procedure is started, for example, by a trigger that the electric power control unit 401 switches the electric power supply mode to the low electric power consumption mode.

A start of this procedure causes the human body detecting unit 404 to start detecting the existence of the human body. Then, the cycle changing unit 405 determines whether or not the cycle changing unit 405 needs to change the cycle of the operation confirmation performed by the operation confirming unit 402 corresponding to the detection state of the human body detecting unit 404 (Step S601).

As described above, the human body detecting unit 404 of the embodiment includes the two infrared sensors. This causes the human body detecting unit 404 to detect the respective existences of the human body within a first range, which is within a distance range comparatively close to the multi-functional peripheral 100, and within a second range, which is outside of the first range. The second range is within a farther distance range from the multi-functional peripheral 100 than the first range. For example, the cycle changing unit 405 determines the operation confirmation cycle corresponding to each of a state where the human body is detected within the first range, a state where the human body is not detected within the first range, and the human body is detected within the second range, and a state where the human body is not detected within either the first range or the second range. Then, when an additionally determined operation confirmation cycle is different from an operation confirmation cycle that has determined immediately before, the cycle changing unit 405 determines that the cycle changing unit 405 needs to change the operation confirmation cycle (Yes at Step S601). When the additionally determined operation confirmation cycle is identical to the operation confirmation cycle that has determined immediately before, the cycle changing unit 405 determines that the cycle changing unit 405 does not need to change the operation confirmation cycle (No at Step S601). The cycle changing unit 405, which determines that the cycle changing unit 405 needs to change the operation confirmation cycle, inputs the additionally determined operation confirmation cycle to the operation confirming unit 402. The operation confirming unit 402 performs the operation confirmation in the input operation confirmation cycle corresponding to this input (Step S602).

Not specifically limited, the cycle changing unit 405 of the embodiment determines the cycle of the operation confirmation performed by the operation confirming unit 402 corresponding to the detection state of the human body detecting unit 404 at a time point of switching to the low electric power consumption mode.

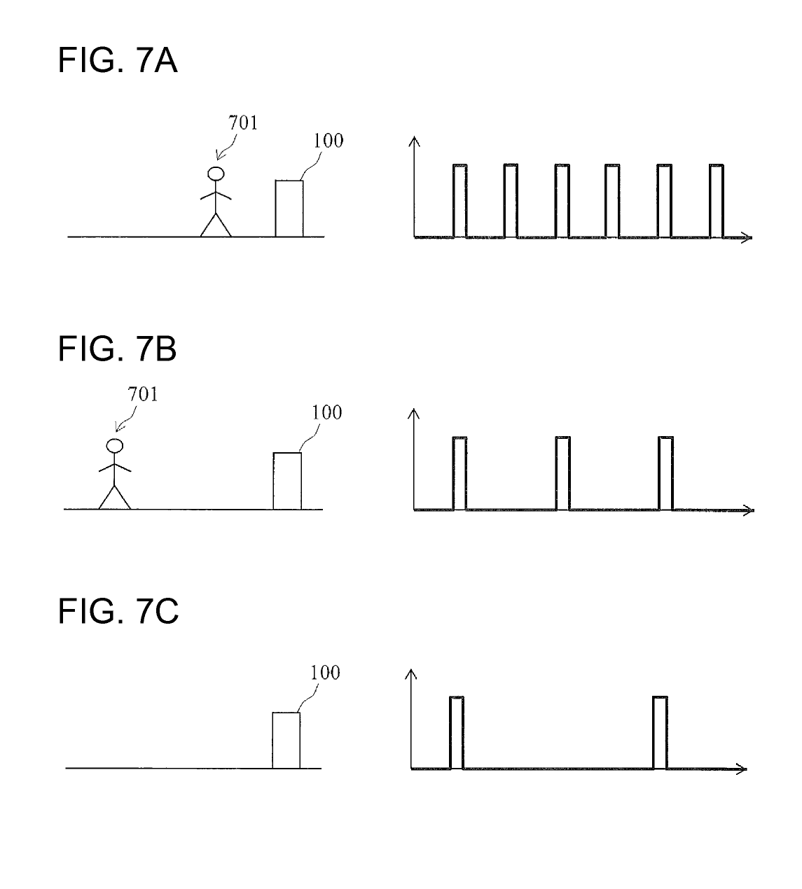

FIGS. 7A to 7C schematically illustrate an exemplary relationship between a human body detection state of the human body detecting unit 404 and an operation confirmation cycle (a cycle of the above-described operation confirmation timing signal) of the operation confirming unit 402. FIG. 7A corresponds to a case where the human body is within the first range. FIG. 7B corresponds to a case where the human body is not within the first range, and is within the second range. FIG. 7C corresponds to a case where the human body is not within either the first range or the second range.

As illustrated in FIG. 7A, when the human body is detected within the first range, the cycle changing unit 405 determines the operation confirmation cycle as a predetermined short cycle. As illustrated in FIG. 7B, when the human body is not detected within the first range, and is detected within the second range, the cycle changing unit 405 determines the operation confirmation cycle as a medium cycle whose period of the Low level is longer than the short cycle. Additionally, as illustrated in FIG. 7C, when the human body is not detected within the first range or the second range, the cycle changing unit 405 determines the operation confirmation cycle as a long cycle whose period of the Low level is longer than the medium cycle. Every cycle includes the identical period when the High level of the operation confirmation timing signal is maintained. This is caused by the embodiment that a maintenance period of the High level signal is the minimum period required for detecting operation existence.

Thus, the longer operation confirmation cycle (a smaller duty ratio) ensures less usage of electric power to detect a return timing in the low electric power consumption mode than a configuration that does not change the operation confirmation cycle.

As described above, the operation confirming unit 402 detects existence of the operation to the operation panel 200 in accordance with the operation confirmation cycle determined (changed) by the cycle changing unit 405 (Step S603). As described above, this detection is performed when the operation confirmation timing signal is at the High level.

When the operation confirming unit 402 detects the operation to the operation panel 200, the operation confirming unit 402 notifies the electric power mode switching unit 403 of its detection (Yes at Step S603). Next, the electric power mode switching unit 403, which receives this notification, instructs the electric power control unit 401 to switch to the standby mode. And then, the electric power control unit 401 switches the electric power supply mode to the standby mode corresponding to this instruction (Step S604). On the other hand, when the operation confirming unit 402 does not detect the operation to the operation panel 200, the electric power control unit 401 maintains the low electric power consumption mode (No at Step S603).

The above has described a configuration that the cycle changing unit 405 determines the operation confirmation cycle as the long cycle when the human body is not detected within the first range or the second range. However, the embodiment can employ a configuration that the operation confirming unit 402 does not perform the operation confirmation when the human body is not detected within the first range or the second range.

As described above, this multi-functional peripheral 100 can change the cycle of the operation confirmation performed by the operation confirming unit 402 corresponding to the detection state of the human body detecting unit 404. Thus, for example, when the human body detecting unit 404 detects the human body, the multi-functional peripheral 100 can shorten the operation confirmation cycle. When the human body detecting unit 404 does not detects the human body, the multi-functional peripheral 100 can lengthen the operation confirmation cycle. Namely, the low possibility of using the multi-functional peripheral 100 causes low monitor frequency of the operation to the operation panel 200 to reduce electric power consumption required for the operation confirmation. The high possibility of using the multi-functional peripheral 100 causes high monitor frequency of the operation to the operation panel 200 to detect reliably the operation to the operation panel 200.

The embodiment described above has described a configuration that includes two infrared sensors, however a multi-functional peripheral may employ a configuration that includes three or more than three infrared sensors to execute human body detection within a distance range corresponding to the respective infrared sensors. The multi-functional peripheral may employ a configuration that includes one infrared sensor to change an operation confirmation cycle when detecting a human body and when not detecting the human body.

While in the embodiment described above employs a configuration that the cycle changing unit 405 changes the operation confirmation cycle corresponding to the distance from the human body detected by the multi-functional peripheral 100 and the human body detecting unit 404, the disclosure may employ a configuration that detects a movement direction of the human body, and the cycle changing unit 405 changes the operation confirmation cycle corresponding to the movement direction. For example, the multi-functional peripheral may employ a configuration that shortens the operation confirmation cycle when the human body moves in a direction approaching the multi-functional peripheral 100. The multi-functional peripheral may additionally employ a configuration that lengthens the operation confirmation cycle when the human body moves in a direction separating from the multi-functional peripheral 100.

Furthermore, the embodiment described above has described the touch panel display 201 and the operation button 203 as an example of the operated unit. However, any configuration is possible insofar as the operated unit is a part operated by a user. For example, assuming the sheet feed cassettes 152, 153, and 154 as the operated units, the multi-functional peripheral can include a configuration that the operation confirming unit 402 periodically confirms an operation (pull out or store in) to the sheet feed cassettes 152, 153, and 154.

The flowchart illustrated in FIG. 6 can be appropriately changed in a case of a range that achieves equivalent action. For example, the multi-functional peripheral may employ a configuration that the cycle changing unit 405 confirms a detection state change of the human body detecting unit 404 in an identical cycle to or a shorter cycle than the operation confirmation cycle to change the operation confirmation cycle only when detecting the detection state change of the human body detecting unit 404.

While the embodiment described above has additionally embodied the disclosure as a digital multi-functional peripheral, it is not limited to the digital multi-functional peripheral. The disclosure is applicable to any electronic device such as a printer and a copier including any image forming apparatus.

According to the disclosure, the electronic device can detect a return timing in the low electric power consumption mode with low electric power consumption, and is useful as the electronic device.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. An electronic device comprising:
an operation panel that receives an operation;
an electric power control circuit that switches a plurality of electric power supply modes including a standby mode that ensures execution of at least one function and a low electric power consumption mode that uses less electric power consumption amount than an electric power consumption amount of the standby mode;
an operation confirming circuit that periodically confirms an operation to the operation panel in the low electric power consumption mode;
an electric power mode switching circuit that causes the electric power control circuit to switch the electric power supply mode when the operation confirming circuit detects the operation to the operation panel;
a human body detecting circuit that detects existence of a human body within a predetermined range; and
a cycle changing circuit that changes an operation confirmation cycle by the operation confirming circuit corresponding to a detection state of the human body detecting circuit.

2. The electronic device according to claim 1, wherein the cycle changing circuit changes the operation confirmation cycle corresponding to a distance between the electronic device and the human body detected by the human body detecting circuit.

3. The electronic device according to claim 2, wherein the cycle changing circuit increases the operation confirmation cycle with increasing distance between the electronic device and the human body detected by the human body detecting circuit.

4. The electronic device according to claim 1, wherein the operation confirming circuit detects a press of an operation button as the operation panel.

5. The electronic device according to claim 1, wherein the operation confirming circuit detects pressing force of a touch panel as the operation panel.

6. The electronic device according to claim 1, wherein:
the electronic device is an image forming apparatus that includes an image forming circuit; and
the electric power mode switching circuit causes the electric power control circuit to switch the electric power supply mode to the standby mode that ensures execution of an image processing from the low electric power consumption mode where an image processing is inexecutable.
